(19) United States
(12) Patent Application Publication
(10) Pub. No.: US 2006/0031681 A1
(43) Pub. Date: Feb. 9, 2006

(54) Method and system for controlling access to a wireless client device

(75) Inventors: Ronald R. Smith, Coral Springs, FL (US); Jyh-Han Lin, Parkland, FL (US); Biren R. Patel, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/912,600

(22) Filed: Aug. 5, 2004

(51) Int. Cl. H04L 9/00

(52) U.S. Cl. 713/182; 380/270

(57) ABSTRACT

A system (20) for controlling user access to a wireless client device (21) can include a receiver (27) and a processor (28). The processor can be programmed to enable access to a permission settings database (23) over-the-air and dynamically modify at least one permission setting for an API (24) that interfaces with an application (25) residing at least partially on the client device. The processor 28 can be programmed to authenticate an authorized administrator remotely, modify a permission setting, add or remove, update, or enable or disable security for a functional group. An enterprise server (21) can be used as the interface for changing the permissions settings remotely. Furthermore, the enterprise server can be connected through an authorization server (22) to provide any required authorization. Of course, the user can also make allowable changes to the permission settings database via a device user interface (26).

### FIELD OF THE INVENTION

This invention relates generally to permission settings, and more particularly to a method and system for remotely controlling permission settings.

### BACKGROUND OF THE INVENTION

Over the air programming of wireless devices has been used to update software and enable and disable features, but not to control security domain permissions. Currently, the java specifications for small devices offer no scalable solution for controlling security domain permissions or the ability to dynamically add, remove, enable, or disable security functional groups.

The Java Mobile Information Device Profile (MIDP) 2.0 specification details the operations and specification of security domains and details recommended practices, but it fails to discuss any remote scalable way to manage or control user access to permission settings nor does it discuss developer, operator or manufacturer access to add, remove, enable, or disable security functional groups.

The MIDP is a key element of the Java 2 Platform, Mobile Edition (J2ME). When combined with the Connected Limited Device Configuration (CLDC), MIDP provides a standard Java runtime environment for today's most popular mobile information devices, such as cell phones and mainstream personal digital assistants (PDAs). The MIDP specification defines a platform for dynamically and securely deploying optimized, graphical, networked applications, but without a means for scalably controlling security domain permissions or dynamically adding, removing, enabling, or disabling security functional groups.

CLDC and MIDP provide the core application functionality required by mobile applications, in the form of a standardized Java runtime environment and a rich set of Java APIs. Developers using MIDP can write applications once, then deploy them quickly to a wide variety of mobile information devices. MIDP has been widely adopted as the platform of choice for mobile applications. It is deployed globally on millions of phones and PDAs, and is supported by leading integrated development environments (IDEs). Companies around the world have already taken advantage of MIDP to write a broad range of consumer and enterprise mobile applications.

A major new feature of MIDP is its ability to dynamically deploy and update applications over-the-air (OTA). OTA provisioning, previously supported only as a recommended practice, is now required as part of the MIDP 2.0 specification. The MIDP specification defines how MIDlet suites are discovered, installed, updated and removed on mobile information devices. MIDP also enables a service provider to identify which MIDlet suites will work on a given device, and obtain status reports from the device following installation, updates or removal. The MIDP OTA provisioning model ensures a single, standard approach to MIDP application deployment that works across the broad range of mobile devices.

MIDP 2.0 adds a robust end-to-end security model, built on open standards, that protects the network, applications and mobile information devices. MIDP 2.0 supports HTTPS and leverages existing standards such as SSL and WTLS to enable the transmission of encrypted data. In MIDP 2.0, security domains protect against unauthorized access of data, applications and other network and device resources by MIDlet suites on the device. By default MIDlet suites are not trusted, and are assigned to untrusted domains that prevent access to any privileged functionality. To gain privileged access, a MIDlet suite must be assigned to specific domains that are defined on the mobile device, and must be properly signed using the X.509 PKI security standard. In order for a signed MIDlet suite to be downloaded, installed and granted associated permissions, it must be successfully authenticated. These permissions are essentially static once granted and cannot be changed dynamically or shared between a user and a remote administrator.

### SUMMARY OF THE INVENTION

In a first embodiment of the present invention, a method of controlling user access to a wireless client device can include the steps of enabling access to a permission settings database on the client device over-the-air and dynamically modifying at least one permission setting for an application program interface (API) that interfaces with an application residing at least partially on the client device. The application can be a JAVA application or practically any other application that interfaces with the application API. The method can further include the step of authenticating an authorized administrator remotely. The method can also include the step of modifying at least one permission setting for a functional group. The method can also include the step of either adding or removing a function group, updating a functional group, or enabling or disabling a functional group. Note, a functional group can be selectively modified to resolve a conflict among one or more functional groups. Further note that permissions can be managed and set from a server such as an enterprise server. For example, permission settings for the application enabling the selective locking of at least a portion of the permission settings can be remotely controlled.

In a second embodiment of the present invention, a system for controlling user access to a wireless client device can include a receiver and a processor coupled to the receiver. The processor is programmed to enable access to a permission settings database on the client device over-the-air and dynamically modify at least one permission setting for an application program interface that interfaces with an application residing at least partially on the client device. The processor can be further programmed to authenticate an authorized administrator remotely, modify at least one permission setting for a functional group, add or remove a functional group, update a functional group, and enable or disable security for a functional group.

Other embodiments, when configured in accordance with the inventive arrangements disclosed herein, can include a machine readable storage for causing a machine to perform the various processes and methods disclosed herein.

### BRIEF DESCRIPTION OF THE DRAWINGS

FIG. 1 is an illustration of an existing system for controlling access to a wireless client device.

FIG. 2 is a block diagram of a system for controlling access to a wireless client device in accordance with the present invention.

FIG. 3 is a flow chart illustrating a method of controlling access to a wireless client device in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

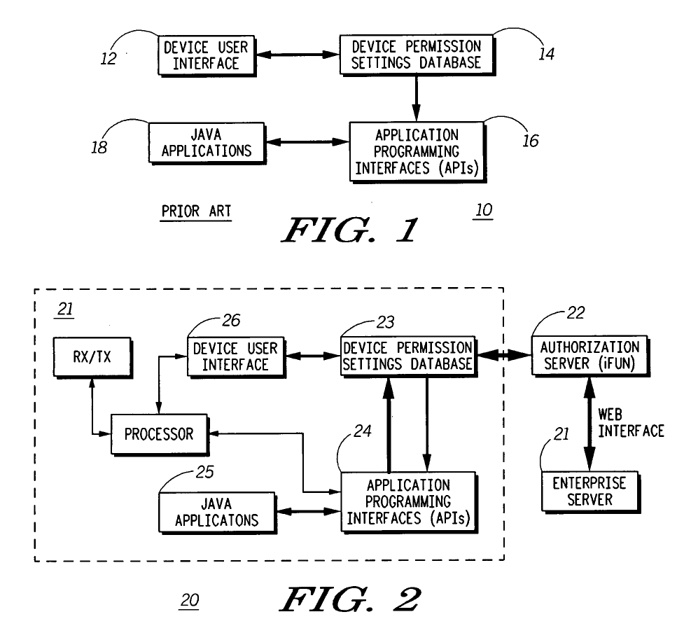

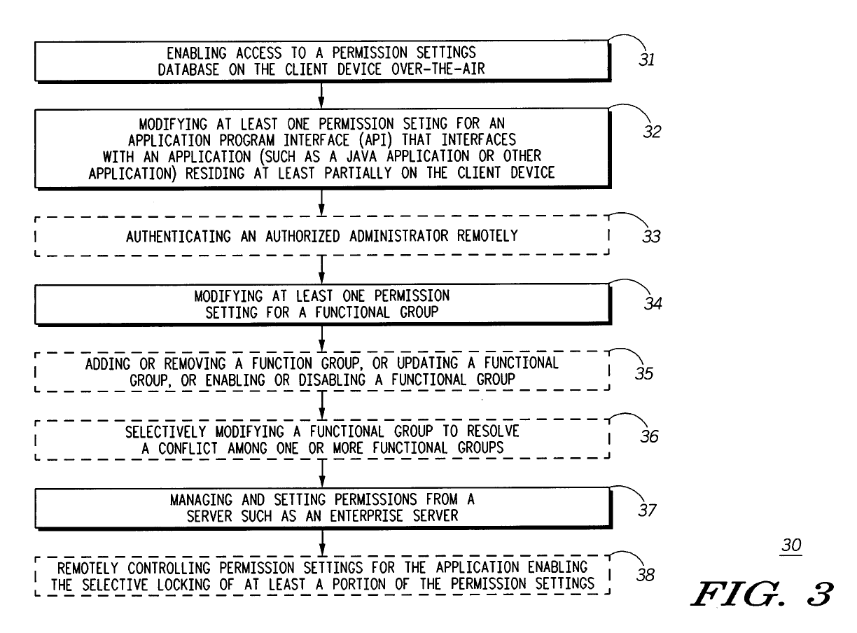

Embodiments in accordance with the present invention provide the ability to expose APIs to a Java developer and to enable them to control user access to permission settings so as to make an application run more efficiently and/or without fear of being denied access to critical data. One example can include controlling the user's access to a location functional group. Currently the user can deny any application access to any functional group through some type of user interface (UI) menu. The users control could render an enterprise application intended to track a handset useless, in that all requests by the application to obtain the device's location would be denied. Of course, granting a user the ability to override such remote control can be part of the dynamic control to give user privacy some priority, but more likely than not in an enterprise application, a remote administrator would retain priority for system efficiency. Developers, network operators and manufacturers have no way to change functional groups once a device has shipped. Embodiments described herein also detail the ability of a handset to provide a method and apparatus for adding, removing, updating, enabling or disabling security functional groups even after a product has been shipped and is in service by the end user. Functional groups are groups of APIs controlled under the same permission setting. Since they are grouped, if some contention arises involving two APIs in the same functional group, the options for conflict resolution are limited if they are static as shown in the existing system 10 of FIG. 1. The system 10 includes a device UI 12 that interfaces with a device permissions setting database 14. In such a system, the permissions are set and control or define the APIs 16 that interface with applications such as JAVA applications 18. Embodiments herein as illustrated in a system 20 of FIG. 2 allow the functional groups to be changed after the device is deployed.

More specifically, referring to FIG. 2 again, the system 20 for controlling user access to a wireless client device 21 such as cellular phone or other wireless client can include a receiver or transceiver 27 and a processor 28 coupled to the receiver 27. The processor 28 can be programmed to enable access to a permission settings database 23 on the client device 21 over-the-air and dynamically modify at least one permission setting for an application program interface 24 that interfaces with an application 25 (such as a Java application) residing at least partially on the client device 21. The processor 28 can be further programmed to authenticate an authorized administrator remotely, modify at least one permission setting for a functional group, add or remove a functional group, update a functional group, and enable or disable security for a functional group. An enterprise server 21 can be used as the interface or conduit for changing the permissions settings remotely. Furthermore, the enterprise server 21 can be connected through an authorization server 22 via a web interface to provide any required authorization. Of course, the user can also make allowable changes to the permission settings database 23 via a device user interface 26.

A method in accordance with the present invention allows for an API to be shipped in the phone that would allow a client server application to control it's own permission settings, by both locking some settings and not allowing the device user to change such settings, but also allowing access to permissions that are not mission critical by the user. The method can also allow an application to be an administrator application that could control the permission settings of the entire device including other applications resident on said device. A method in accordance with several embodiments herein can also add, update, remove, enable and disable functional groups. The method is particularly useful if the grouping of APIs in one or more functional groups need to be changed to resolve a conflict. Furthermore, a method herein can remotely manage features from a server in order to meet the requirements of a fleet of fielded units that need to be updated across a wide geographic area.

More specifically referring to FIG. 3, a flow chart illustrates a method 30 of controlling user and remote access to a wireless client device including the step 31 of enabling access to a permission settings database on the client device over-the-air, dynamically modifying at least one permission setting for an application program interface (API) that interfaces with an application (such as a JAVA application or other application) residing at least partially on the client device at step 32, optionally authenticating an authorized administrator remotely at step 33 and modifying at least one permission setting for a functional group at step 34. The method 30 can further include the steps of adding or removing a function group, updating a functional group, or enabling or disabling a functional group at step 35. Optionally at step 36, the method 30 can selectively modify a functional group to resolve a conflict among one or more functional groups. The method 30 can further include the step 37 of managing and setting permissions from a server such as an enterprise server and the step 38 of remotely controlling permission settings for the application enabling the selective locking of at least a portion of the permission settings

In light of the foregoing description, it should be recognized that embodiments in accordance with the present invention can be realized in hardware, software, or a combination of hardware and software. A system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of controlling user access to a wireless client device, comprising the steps of:
enabling access to a permission settings database on the client device over-the-air; and
dynamically modifying at least one permission setting for an application program interface that interfaces with an application residing at least partially on the client device.

2. The method of claim 1, wherein the method further comprises the step of modifying at least one permission setting for a functional group.

3. The method of claim 1 wherein the application on the client device is a JAVA application.

4. The method of claim 1, wherein the method further comprises the step of adding or removing a functional group.

5. The method of claim 1, wherein the method further comprises the step of updating a functional group.

6. The method of claim 1, wherein the method further comprises the step of enabling or disabling security for a functional group.

7. The method of claim 1, wherein the method further comprises the step of managing the permissions setting from an enterprise server.

8. The method of claim 1, wherein the method further comprises the step of controlling remotely permission settings for the application enabling the selective locking of at least a portion of the permission settings.

9. The method of claim 1, wherein the method further comprises the step of selectively modifying a functional group to resolve a conflict among one or more functional groups.

10. The method of claim 1, wherein the method further comprises the step of authenticating an authorized administrator remotely.

11. A system for controlling user access to a wireless client device, comprising:
a receiver;
a processor coupled to the receiver, wherein the processor is programmed to:
enable access to a permission settings database on the client device over-the-air; and
dynamically modify at least one permission setting for an application program interface that interfaces with an application residing at least partially on the client device.

12. The system of claim 11, wherein the processor is further programmed to authenticate an authorized administrator remotely.

13. The system of claim 11, wherein the processor is further programmed to modify at least one permission setting for a functional group.

14. The system of claim 11, wherein the application on the client device is a JAVA application.

15. The system of claim 11, wherein the processor is further programmed to perform at least one among the functions of adding or removing a functional group, updating a functional group, and enabling or disabling security for a functional group.

16. The system of claim 11, wherein the processor is further programmed to manage the permissions setting from an enterprise server.

17. The system of claim 11, wherein the processor is further programmed to control remotely permission settings for the application enabling the selective locking of at least a portion of the permission settings.

18. The system of claim 11, wherein the processor is further programmed to selectively modify a functional group to resolve a conflict among one or more functional groups.

19. A machine readable storage, having stored thereon a computer program having a plurality of code sections executable by a machine for causing the machine to perform the steps of:
authenticating an authorized administrator remotely;
enabling access to a permission settings database on the client device over-the-air;
modifying at least one permission setting for an application program interface that interfaces with an application residing at least partially on the client device.

20. The machine readable storage of claim 19, wherein the computer program further has a plurality of code sections executable by the machine for causing the machine to perform at least one among the steps of selected from modifying at least one permission setting for a functional group, adding a functional group, removing a functional group, updating a functional group, enabling security for a functional group or disabling security for a functional group.
